(19) United States
(12) Patent Application Publication
(10) Pub. No.: US 2025/0179314 A1
(43) Pub. Date: Jun. 5, 2025

(54) ELECTROCONDUCTIVE PASTE, MIXED MATERIAL PASTE, ELECTRODE FOR LITHIUM-ION BATTERY POSITIVE ELECTRODE, AND BATTERY

(71) Applicants: KANSAI PAINT CO., LTD., Hyogo (JP); OHARA INC., Kanagawa (JP)

(72) Inventors: Yutaro ICHI, Kanagawa (JP); Satoru FURUSAWA, Kanagawa (JP); Takashi KATOH, Kanagawa (JP); Ryohei SATO, Kanagawa (JP)

(73) Assignees: KANSAI PAINT CO., LTD., Hyogo (JP); OHARA INC., Kanagawa (JP)

(21) Appl. No.: 18/843,464

(22) PCT Filed: Mar. 2, 2023
(86) PCT No.: PCT/JP2023/007748

§ 371 Date: Sep. 3, 2024

(30) Foreign Application Priority Data
Mar. 3, 2022 (JP) 2022-033011

(51) Int. Cl. C09D 5/24; H01M 4/02; H01M 4/131; H01M 4/485; H01M 4/62; H01M 10/0525; H01M 10/0562

(52) U.S. Cl. CPC C09D 5/24; H01M 4/131; H01M 4/485; H01M 4/625; H01M 10/0525; H01M 2004/028; H01M 10/0562

(57) ABSTRACT

The present invention addresses the problem of providing a conductive paste that achieves, when used for a lithium-ion secondary battery, low internal resistance and suppression of an increase in internal resistance after repeated charging and discharging. The present invention provides a conductive paste comprising a pigment dispersion resin (A), a conductive carbon (B), an inorganic material (C), and a solvent (D), wherein the pigment dispersion resin (A) has at least one polar functional group selected from the group consisting of an amide group, imide group, ether group, hydroxy group, carboxy group, sulfonate group, phosphate group, silanol group, amino group, and pyrrolidone group, and wherein the inorganic material (C) comprises at least one member selected from the group consisting of a glass, glass ceramic, and ceramic.

### TECHNICAL FIELD

### Cross-Reference to Related Applications

This application claims priority based on Japanese Patent Application No. 2022-033011 filed on Mar. 3, 2022, the entire content of which is incorporated herein by reference. The present invention relates to a conductive paste and a mixture paste, as well as an electrode for positive electrodes of lithium-ion batteries comprising the mixture paste and a battery comprising the mixture paste.

### BACKGROUND ART

A lithium-ion secondary battery is a secondary battery in which lithium ions in the electrolyte are responsible for electrical conduction. A lithium-ion secondary battery has excellent characteristics such that the energy density is high, charged energy-retention properties are excellent, and the memory effect, i.e., the battery's apparent reduction in capacity, is small. Lithium-ion secondary batteries are thus used in a wide range of fields, such as cellular phones, smartphones, personal computers, digital cameras, hybrid automobiles, electric automobiles, and medical devices.

Typically, a lithium-ion secondary battery mainly comprises, for example, a positive-electrode plate, a negative-electrode plate, a separator that insulates the positive-electrode and negative-electrode plates, and an electrolyte. The positive-electrode plate is obtained by forming a positive electrode mixture layer on a surface of a positive electrode core. The positive electrode mixture layer can be produced by applying a positive electrode mixture paste to a surface of a positive electrode core, followed by drying. The positive electrode mixture paste is obtained by mixing an electrode active material with a conductive paste containing a conductive auxiliary agent (e.g., carbon), a binder, and a solvent (PTL 1 to PTL 3).

Lithium-ion secondary batteries are required to achieve a reduction in internal resistance in order to improve durability and input-output characteristics. In particular, due to its usage as a secondary battery, suppressing an increase in internal resistance after repeated charging and discharging is in demand.

### CITATION LIST

### Patent Literature

PTL 1: JP2013-89485A
PTL 2: JP2014-193986A
PTL 3: JPH11-250915A

### SUMMARY OF INVENTION

### Technical Problem

An object of the present invention is to provide a conductive paste that achieves, when used for a lithium-ion secondary battery, low internal resistance and suppression of an increase in internal resistance after repeated charging and discharging.

### Solution to Problem

Under such circumstances, the present inventors conducted extensive research and found that the use of a conductive paste comprising a pigment dispersion resin (A), a conductive carbon (B), an inorganic material (C), and a solvent (D), wherein the pigment dispersion resin (A) has at least one polar functional group selected from the group consisting of an amide group, imide group, ether group, hydroxy group, carboxy group, sulfonate group, phosphate group, silanol group, amino group, and pyrrolidone group, and wherein the inorganic material (C) comprises at least one member selected from the group consisting of a glass, glass ceramic, and ceramic, can solve the above problem. The present invention thus provides the following items.

Item 1. A conductive paste comprising a pigment dispersion resin (A), a conductive carbon (B), an inorganic material (C), and a solvent (D),
wherein the pigment dispersion resin (A) has at least one polar functional group selected from the group consisting of an amide group, imide group, ether group, hydroxy group, carboxy group, sulfonate group, phosphate group, silanol group, amino group, and pyrrolidone group, and
wherein the inorganic material (C) comprises at least one member selected from the group consisting of a glass, glass ceramic, and ceramic.

Item 2. The conductive paste according to Item 1, wherein the pigment dispersion resin (A) has a polar functional group concentration of 0.1 to 23 mmol/g.

Item 3. The conductive paste according to Item 1 or 2, wherein the pigment dispersion resin (A) comprises a polyvinyl alcohol resin (a1) having a saponification degree of 30 to 100 mol %.

Item 4. The conductive paste according to any one of Items 1 to 3, wherein the pigment dispersion resin (A) comprises an acrylic resin (a2).

Item 5. The conductive paste according to any one of Items 1 to 4, wherein the conductive carbon (B) comprises acetylene black (b1) and/or a carbon nanotube (b2).

Item 6. The conductive paste according to any one of Items 1 to 5, wherein the conductive carbon (B) comprises a carbon nanotube (b2).

Item 7. The conductive paste according to Item 5 or 6, wherein the carbon nanotube (b2) has a fiber length of 0.1 to 100 μm and an outer diameter of 1 to 30 nm.

Item 8. The conductive paste according to any one of Items 1 to 7, wherein the inorganic material (C) comprises, on a percent by mass basis,
P₂O₅: 15 to 60%,
SiO₂: 0 to 15%,
MO₂: 20 to 45%, wherein M represents one or more members selected from the group consisting of Ti, Zr, Ge, Sn, Nb, and Hf,
A₂O₃: 0 to 25%, wherein A represents one or more members selected from the group consisting of Al, Y, and Sc,
EO: 0 to 25%, wherein E represents one or more members selected from the group consisting of Mg and Ca, and
Li₂O: 3 to 20%.

Item 9. The conductive paste according to Item 8,
wherein the inorganic material (C) is a glass ceramic and/or ceramic in which a crystal of Li₁₊ₓM1_{y}M2_{2-y}Si_{z}P_{1-z}O₁₂ (0<x<2, 0<y<2, 0≤z≤1) is precipitated, wherein in the formula, M1 represents one or more members selected from the group consisting of Al, Ca, Y, Mg, and Sc, and M2 represents one or more members selected from the group consisting of Ti, Zr, Ge, Sn, Nb, and Hf.

Item 10. The conductive paste according to any one of Items 1 to 9, wherein the solubility parameter δA of the pigment dispersion resin (A) and the solubility parameter δD of the solvent (D) satisfy the relationship |δA−δD|<2.0.

Item 11. The conductive paste according to any one of Items 1 to 10, wherein the solvent (D) comprises N-methyl-2-pyrrolidone.

Item 12. The conductive paste according to any one of Items 1 to 11, wherein the conductive paste has a water content of less than 1.0 mass %.

Item 13. A mixture paste comprising the conductive paste of any one of Items 1 to 12, and further comprising an electrode active material (E).

Item 14. A mixture paste comprising a pigment dispersion resin (A), a conductive carbon (B), an inorganic material (C), a solvent (D), and an electrode active material (E),
wherein the pigment dispersion resin (A) has at least one polar functional group selected from the group consisting of an ester group, amide group, imide group, ether group, hydroxy group, carboxy group, sulfonate group, phosphate group, silanol group, amino group, and pyrrolidone group, and
wherein the inorganic material (C) comprises at least one member selected from the group consisting of a glass, glass ceramic, and ceramic.

Item 15. An electrode for positive electrodes of non-aqueous electrolyte lithium-ion batteries obtained by using the mixture paste of Item 13 or 14.

Item 16. An electrode for positive electrodes of solid electrolyte lithium-ion batteries obtained by using the mixture paste of Item 13 or 14.

Item 17. An all-solid-state battery obtained by using the electrode for positive electrodes of Item 16.

### Advantageous Effects of Invention

The present invention can provide a conductive paste that achieves, when used for a lithium-ion secondary battery, low internal resistance and suppression of an increase in internal resistance after repeated charging and discharging.

### DESCRIPTION OF EMBODIMENTS

In the present specification, the singular forms (e.g., a, an, and the) shall include both the singular and plural forms, unless otherwise indicated herein or clearly contradicted by context.

### Conductive Paste

The present invention provides a conductive paste comprising a pigment dispersion resin (A), a conductive carbon (B), an inorganic material (C), and a solvent (D), wherein the pigment dispersion resin (A) has at least one polar functional group selected from the group consisting of an amide group, imide group, ether group, hydroxy group, carboxy group, sulfonate group, phosphate group, silanol group, amino group, and pyrrolidone group, and wherein the inorganic material (C) comprises at least one member selected from the group consisting of a glass, glass ceramic, and ceramic.

### Pigment Dispersion Resin (A)

The pigment dispersion resin (A) has at least one polar functional group selected from the group consisting of an amide group, imide group, ether group, hydroxy group, carboxy group, sulfonate group, phosphate group, silanol group, amino group, and pyrrolidone group. The polar functional group concentration in the pigment dispersion resin (A) is not particularly limited and is usually within the range of 0.1 to 23 mmol/g, preferably 5 to 22.5 mmol/g, and more preferably 11 to 22 mmol/g, from the viewpoint of dispersibility, storage stability, and compatibility with solvents.

Specific examples of the types of resin for the pigment dispersion resin (A) include acrylic resins, polyester resins, epoxy resins, polyether resins, alkyd resins, urethane resins, polyvinyl alcohol, polyvinyl acetal, polyvinylpyrrolidone, polyvinyl acetate, silicone resins, polycarbonate resins, silicate resins, chlorine-based resins, fluorine-based resins, and composite resins thereof. These resins may be used alone or in a combination of two or more.

In particular, the pigment dispersion resin (A) preferably comprises a vinyl (co)polymer (A′) obtained by polymerizing or copolymerizing one or more monomers, including a polymerizable unsaturated group-containing monomer of formula (1) below.

The term “(co)polymer” in the present invention includes both a polymer obtained by polymerizing a single type of monomer and a copolymer obtained by copolymerizing two or more types of monomers.

C(—R)²═C(—R)² Formula (1)

In the formula, R may be the same or different, and each represents a hydrogen atom or an organic group.

The vinyl (co)polymer (A′) preferably comprises in its structure a structural unit represented by “—CH₂—CH(—X)—” wherein X represents an organic group having a polar functional group. The polar functional group X in the structural unit is at least one polar functional group selected from the group consisting of an amide group, imide group, ether group, hydroxy group, carboxy group, sulfonate group, phosphate group, silanol group, amino group, and pyrrolidone group. In the present invention, “pyrrolidone group” refers to a monovalent group obtained by removing the hydrogen atom from the —NH— portion in pyrrolidone.

Examples of the vinyl (co)polymer (A′) include hydroxy group-containing vinyl (co)polymers, carboxy group-containing vinyl (co)polymers, pyrrolidone group-containing vinyl (co)polymers, amide group-containing vinyl (co)polymers, sulfonate group-containing vinyl (co)polymers, phosphate group-containing vinyl (co)polymers, and amino group-containing vinyl (co)polymers. These (co)polymers may be used alone or in a combination of two or more.

Examples of hydroxy group-containing vinyl (co)polymers include polyhydroxyethyl (meth)acrylate, polyvinyl alcohol, vinyl alcohol-fatty acid vinyl copolymers, vinyl alcohol-ethylene copolymers, vinyl alcohol-(N-vinylformamide) copolymers, and copolymers of hydroxyethyl (meth)acrylate with other polymerizable unsaturated group-containing monomers. The vinyl alcohol unit in the (co)polymers may be one obtained by hydrolysis after (co)polymerization with a fatty acid vinyl unit.

Examples of carboxy group-containing vinyl (co)polymers include polymers of (meth)acrylic acid and copolymers of poly(meth)acrylic acid with other polymerizable unsaturated group-containing monomers.

Examples of pyrrolidone group-containing vinyl (co)polymers include polyvinylpyrrolidone, N-vinyl-2-pyrrolidone-ethylene copolymers, and N-vinyl-2-pyrrolidone-vinyl acetate copolymers.

Examples of amide group-containing vinyl (co)polymers include polymers of (meth)acrylamide and copolymers of (meth)acrylamide with other polymerizable unsaturated group-containing monomers.

Examples of sulfonate group-containing vinyl (co)polymers include polymers of allylsulfonic acid, styrenesulfonic acid, or the like, and copolymers of allylsulfonic acid and/or styrenesulfonic acid with other polymerizable unsaturated group-containing monomers.

Examples of phosphate group-containing vinyl (co)polymers include polymers of (meth)acryloyloxyalkyl acid phosphate, and copolymers of (meth)acryloyloxyalkyl acid phosphate with other polymerizable unsaturated group-containing monomers.

Examples of amino group-containing vinyl (co)polymers include polyvinylamine, polyallylamine, polymers of dimethylaminoethyl (meth)acrylate, and copolymers of dimethylaminoethyl (meth)acrylate with other polymerizable unsaturated group-containing monomers.

Among the above, the vinyl (co)polymer (A′) is preferably a hydroxy group-containing polyvinyl (co)polymer, carboxy group-containing polyvinyl (co)polymer, a pyrrolidone group-containing polyvinyl (co)polymer, or the like, and more preferably a hydroxy group-containing polyvinyl (co)polymer or the like, from the viewpoint of improving dispersibility and storability and reducing the resistance of the conductive paste. The type of resin is even more preferably a polyvinyl alcohol resin (a1) and/or acrylic resin (a2), and still more preferably a polyvinyl alcohol resin (a1).

The polyvinyl alcohol resin (a1) may be a modified or unmodified polyvinyl alcohol resin. The saponification degree of the polyvinyl alcohol resin (a1) is not particularly limited and is usually 30 to 100 mol %, preferably 65 to 99.9 mol %, and more preferably 85 to 99.9 mol %.

The vinyl (co)polymer (A′) can be produced by a known polymerization method. For example, solution polymerization is preferably used. However, the method is not limited to this and may be bulk polymerization, emulsion polymerization, suspension polymerization, or the like. In solution polymerization, either continuous polymerization or batch polymerization may be performed, monomers may be added all at once or in divided portions, and the addition may be performed successively or intermittently.

The polymerization initiator used in solution polymerization is not particularly limited. Specific examples include the following known radical polymerization initiators: azo compounds, such as azobisisobutyronitrile, azobis-2,4-dimethylvaleronitrile, and azobis(4-methoxy-2,4-dimethylvaleronitrile); peroxides, such as acetyl peroxide, benzoyl peroxide, lauroyl peroxide, acetylcyclohexylsulfonyl peroxide, and 2,4,4-trimethylpentyl-2-peroxyphenoxyacetate; percarbonate compounds, such as diisopropyl peroxydicarbonate, di-2-ethylhexyl peroxydicarbonate, and diethoxyethyl peroxydicarbonate; perester compounds, such as t-butylperoxy neodecanoate, α-cumylperoxy neodecanoate, and t-butylperoxy neodecanoate; azobis dimethylvaleronitrile; azobis methoxyvaleronitrile; and the like.

The polymerization reaction temperature is not particularly limited and can usually be set within the range of about 30 to 200° C.

The vinyl (co)polymer (A′) thus obtained preferably has a polymerization degree of 100 to 4,000, more preferably 100 to 3,000, and even more preferably 150 to 700.

The weight average molecular weight of the pigment dispersion resin (A) is not limited and is preferably 1,000 to 200,000, more preferably 2,000 to 100,000, and even more preferably 7,000 to 30,000. In the present invention, the weight average molecular weight can be measured with GPC equipped with an RI detector.

Specifically, the measurement is performed by using a gel permeation chromatography (GPC) apparatus HLC8120GPC (trade name, produced by Tosoh Corporation) and using four columns, i.e., TSKgel G-4000HXL, TSKgel G-3000HXL, TSKgel G-2500HXL, and TSKgel G-2000HXL (trade names, all produced by Tosoh Corporation), under the conditions in which the mobile phase is tetrahydrofuran, the measurement temperature is 40° C., the flow rate is 1 mL/min, and the detector is RI.

After the completion of the synthesis, the vinyl (co)polymer (A′) may be subjected to solvent removal and/or solvent replacement to obtain a solid or a resin solution whose solvent has been replaced with a desired solvent.

Solvent removal may be performed by heating under ordinary pressure. Solvent removal may also be performed under reduced pressure. Solvent replacement may be performed by introducing a solvent for replacement at any step of before, during, or after solvent removal.

The solids content of the pigment dispersion resin (A) is, for example, 0.1 mass % or more, preferably 0.5 mass % or more, and more preferably 1 masse or more, and is, for example, 10 mass % or less, preferably 7.5 mass % or less, and more preferably 5 mass % or less, based on the total solids content of the conductive paste

The solids content of the pigment dispersion resin (A) is, for example, 0.1 mass % or more, preferably 0.5 mass % or more, and more preferably 1 mass % or more, and is, for example, 20 mass % or less, preferably 15 mass % or less, and more preferably 10 mass % or less, based on the content of the conductive carbon (B).

### Conductive Pigment (B)

The conductive pigment (B) for use can be any conductive pigment that can be used in the technical field of conductive pastes to which the present invention belongs, and preferably comprises a carbon nanotube (B-1) and/or a conductive carbon (B-2) with an average particle size of 10 to 80 nm. The conductive pigment (B) may further comprise an additional conductive pigment (B-3), which is other than the carbon nanotube (B-1) and other than the conductive carbon (B-2) with an average particle size of 10 to 80 nm.

### Carbon Nanotube (B-1)

The carbon nanotube (B-1) for use may be a single-walled carbon nanotube or multi-walled carbon nanotube, which may be used alone or in combination. In particular, in relation to viscosity, conductivity, and cost, the use of a multi-walled carbon nanotube is preferable.

The average outer diameter of the carbon nanotube (B-1) is not particularly limited and is, for example, 1 nm or more, preferably 3 nm or more, and more preferably 5 nm or more, and is, for example, 30 nm or less, preferably 25 nm or less, and more preferably 20 nm or less. The average outer diameter of the carbon nanotube (B-1) can be determined by observing the morphology of, for example, 100 carbon nanotubes under a transmission electron microscope, measuring the lengths of their minor axes, and calculating the number average value.

The average length of the carbon nanotube (B-1) is not particularly limited and is, for example, 0.1 μm or more, preferably 1 μm or more, and more preferably 5 μm or more. The upper limit of the average length of the carbon nanotube (B-1) is not particularly limited and is, for example, 100 μm or less, preferably 80 μm or less, and more preferably 60 μm or less. The average length of the carbon nanotube (B-1) can be determined by observing the morphology of, for example, 100 carbon nanotubes under an SEM, measuring the fiber lengths, and calculating the number average value.

The specific surface area of the carbon nanotube (B-1) is not particularly limited and is, for example, 1 m²/g or more, and preferably 10 m²/g or more, and is, for example, 1000 m²/g or less, and more preferably 500 m²/g or less, in relation to viscosity and conductivity. The specific surface area of the carbon nanotube (B-1) can be measured with a fully automatic specific surface area measuring device.

Conductive Carbon (B-2) with an Average Particle Size of 10 to 80 nm

The conductive carbon (B-2) with an average particle size of 10 to 80 nm refers to a conductive carbon with an average primary particle size of 10 to 80 nm. Examples of the conductive carbon (B-2) with an average primary particle size of 10 to 80 nm include at least one conductive carbon selected from the group consisting of acetylene black, Ketjen black, furnace black, thermal black, graphene, and graphite. The conductive carbon (B-2) is preferably one or more members selected from the group consisting of acetylene black, Ketjen black, furnace black, and thermal black, more preferably one or more members selected from the group consisting of acetylene black and Ketjen black, and even more preferably one or more types of acetylene black. The one or more types of acetylene black refer to one or more types of acetylene black with one or more different physical properties, such as average primary particle size, BET specific surface area, pH, and DBP oil absorption.

The average primary particle size of the conductive carbon (B-2) as used here refers to an average primary particle size obtained by observing the conductive carbon (B-2) under an electron microscope, calculating the projected area of individual 100 particles, determining the diameters of hypothetical circles equal to those areas, and then simply averaging the diameters of the 100 particles. If the pigment is in an aggregated state, the calculation is performed with the primary particles that make up the aggregated particles.

The BET specific surface area of the conductive carbon (B-2) is not particularly limited. The BET specific surface area is, for example, 1 m²/g or more, preferably 10 m²/g or more, and more preferably 20 m²/g or more, and is, for example, 500 m²/g or less, preferably 250 m²/g or less, and more preferably 200 m²/g or less, in relation to viscosity and conductivity.

The dibutyl phthalate (DBP) oil absorption of the conductive carbon (B-2) is not particularly limited. The dibutyl phthalate (DBP) oil absorption is, for example, 60 ml/100 g or more, and preferably 150 ml/100 g or more, and is, for example, 1,000 ml/100 g or less, and preferably 800 ml/100 g or less, in relation to pigment dispersibility and conductivity.

The conductive carbon (B-2) is preferably in the state in which the primary particles form a chain structure, from the viewpoint of conductivity. The structural index is not limited and is, for example, 1.5 or more, and preferably 1.7 or more. The lower limit of the structural index is preferably in the above range, from the viewpoint of developing the structure and obtaining sufficient conductivity. The upper limit of the structural index is also not limited and is 4.0 or less, and preferably 3.2 or less. The upper limit of the structural index is preferably in the above range from the viewpoint of preventing the particle size from becoming too large with respect to the DBP oil absorption (thereby suppressing a reduction in conductive paths) to thus obtain sufficient conductivity, and further preventing the viscosity of the paste from increasing.

The structure itself can be relatively easily observed with images taken with an electron microscope. The structural index is a numerical value that quantifies the degree of the structure. The structural index can typically be defined as a value obtained by dividing DBP oil absorption (ml/100 g) by specific surface area (m²/g).

### Additional Conductive Pigment (B-3)

The conductive pigment (B) may comprise an additional conductive pigment (B-3). The additional conductive pigment (B-3) is a conductive pigment that is other than the carbon nanotube (B-1) and is other than the conductive carbon (B-2) with an average particle size of 10 to 80 nm.

Examples of the additional conductive pigment (B-3) include one or more members selected from the group consisting of metal powders, metal fibers, metal compounds, and conductive ceramics. The metal in the metal powders, metal fibers, metal compounds, etc. may be, for example, one or more metal elements selected from the group consisting of copper, silver, gold, nickel, aluminum, titanium, and the like.

Specific examples include one or more members selected from the following:
metal powders of copper, silver, gold, nickel, aluminum, titanium, etc.;
metal compounds doped with various elements, such as antimony-doped tin oxide and phosphorus-doped tin oxide;
coated pigments, such as needle-shaped titanium oxide, antimony oxide, zinc antimonate, and indium tin oxide, each having a surface coated with tin oxide and/or antimony, pigments in which the whiskers on the surface of carbon or graphite are coated with tin oxide etc., and pigments in which the surface of flake-like mica is coated with at least one conductive metal oxide selected from the group consisting of tin oxide, antimony-doped tin oxide, tin-doped indium oxide (ITO), fluorine-doped tin oxide (FTO), phosphorus-doped tin oxide, and nickel oxide; and
conductive pigments comprising tin oxide and phosphorus on the surface of titanium dioxide particles.

### Inorganic Material (C)

The conductive paste of the present invention is characterized in that the inorganic material (C) comprises at least one member selected from the group consisting of a glass, glass ceramic, and ceramic. Of these inorganic materials (C), in the present invention, a glass ceramic is preferable. Further, in the present invention, the inorganic material (C) is preferably an electrolyte that provides the conductive paste with ionic conductivity (e.g., lithium ion conductivity). In the present invention, the inorganic material (C) preferably comprises, on a percent by mass basis,
P₂O₅: 15 to 60%,
SiO₂: 0 to 15%,
MO₂: 20 to 45%, wherein M represents one or more members selected from the group consisting of Ti, Zr, Ge, Sn, Nb, and Hf,
A₂O₃: 0 to 25%, wherein A represents one or more members selected from the group consisting of Al, Y, and Sc,
EO: 0 to 25%, wherein E represents one or more members selected from the group consisting of Mg and Ca, and
Li₂O: 3 to 20%,
more preferably
P₂O₅: 25 to 47%,
SiO₂: 0 to 12%,
MO₂: 25 to 45%, wherein M represents one or more members selected from the group consisting of Ti, Zr, and Ge,
A₂O₃: 0 to 18%, wherein A represents one or more members selected from the group consisting of Al and Y,
EO: 0 to 15%, wherein E represents one or more members selected from the group consisting of Mg and Ca, and
Li₂O: 5 to 20%, and most preferably
P₂O₅: 30 to 42%,
SiO₂: 0 to 9%,
TiO₂: 30 to 45%,
Al₂O₃: 0 to 12%, and
Li₂O: 9 to 20%.

When a glass is used as the inorganic material (C), the glass may be, for example, a glass electrolyte. Examples of glass electrolytes include a glass electrolyte represented by Li₂O-G (G=one or more of Al₂O₃, Nb₂O₅, Y₂O₃, SiO₂, B₂O₅, P₂O₅, V₂O₅, TeO₂, CeO₂, GeO₂, Bi₂O₃, and the like). The glass electrolyte is not particularly limited as long as the lithium concentration is 15 mass % or more in terms of oxide, the form is amorphous, and the lithium ion conductivity at room temperature is 1×10⁻¹¹ S/cm or more. A glass electrolyte that has particularly excellent characteristics has a basic composition represented by Li₂O—Al₂O₃—P₂O₅. The content of each component in the glass electrolyte of the present invention is expressed in mass % in terms of oxide, unless otherwise specified. The “composition in terms of oxide” as used here refers to the composition of the components contained in a glass electrolyte, with the total mass of the formed oxides taken as 100 mass %, assuming that the oxides, composite salts, metal fluorides, etc. used as starting materials for the glass electrolyte are all decomposed and converted to oxides at the time of melting.

The ceramic and/or glass ceramic used as the inorganic material (C) is preferably a ceramic electrolyte and/or glass ceramic electrolyte.

In a ceramic and/or glass ceramic used as the inorganic material (C), a crystal represented by Li₁₊ₓM1_{y}M2_{2-y}Si_{z}P_{1-z}O₁₂ (0<x<2, 0<y<2, 0≤z≤1) is preferably precipitated, wherein in the formula, M1 represents one or more members selected from the group consisting of Al, Ca, Y, Mg, and Sc, and M2 represents one or more members selected from the group consisting of Ti, Zr, Ge, Sn, Nb, and Hf.

The ceramic electrolyte or glass ceramic electrolyte is not particularly limited and is preferably a lithium-containing phosphate compound with a rhombohedral crystal system. Materials of different compositions may be mixed or combined. The surface may be coated with a glass electrolyte or the like. Alternatively, it is also possible to use a glass ceramic in which a crystalline phase of a lithium-containing phosphate compound with a NASICON-type structure is precipitated by heat treatment. Other than those with the NASICON structure, it is also possible to use a solid electrolyte that comprises Li, La, Mg, Ca, Fe, Co, Cr, Mn, Ti, Zr, Sn, Y, Sc, P, Si, O, In, Nb, and/or F, has a LISICON-type, perovskite-type, β-Fe₂(SO₄)₃-type, and/or Li₃In₂(PO₄)₃-type crystal structure, and has Li ion conductivity at room temperature of 1×10⁻⁵ S/cm or more. These electrolytes may be used by mixing.

In the present specification, the glass ceramic refers to a material obtained by precipitating a crystalline phase in a glass phase by heat treatment of glass, also refers to a material comprising an amorphous solid and a crystal, and includes a material in which glass phases have all undergone a phase transition to a crystalline phase, i.e., a material in which the amount of crystals (degree of crystallinity) is 100 mass %. Even in a glass ceramic that is a 100% crystallized material, almost no voids are observed between the crystal particles or within the crystals. In contrast, typical ceramics and sintered materials have unavoidable voids and/or crystal grain boundaries between crystal particles and within the crystals due to their production process, and can be distinguished from the glass ceramic used in the present invention. For glass ceramics, by controlling the crystallization process, a decrease in conductivity between crystals can be suppressed, making it easy to achieve conductivity that is comparable to the inherent conductivity of the crystal particles themselves.

In the present invention, the average particle size of the glass, ceramic, and/or glass ceramic contained in the inorganic material (C) is not particularly limited, and is preferably 3 μm or less, more preferably 1 μm or less, and most preferably 0.5 μm or less, in consideration of the active material particle size in electrodes and electrode thickness, and in order to easily achieve excellent dispersibility in electrodes. The lower limit of the average particle size of the glass, ceramic, and/or glass ceramic in the inorganic material (C) is also not limited and is preferably 0.01 μm or more, more preferably 0.05 μm or more, and most preferably 0.10 μm or more in order to easily achieve excellent dispersion in electrodes and excellent bonding between electrode materials.

The average particle size of the glass, ceramic, and/or glass ceramic in the inorganic material (C) is the value of D50 (50% cumulative particle diameter) as measured by a laser diffraction method. Specifically, a value measured with a particle size analyzer (Microtrac MT3300EXII, produced by Nikkiso Co., Ltd.) or a submicron particle analyzer (N5, produced by Beckman Coulter) may be used. The above average particle sizes are expressed on a volume basis.

The inorganic material (C) of the present invention for use may be a commercially available lithium ion conductive glass ceramic with the above composition and physical properties. Examples of commercial products include LICGC™ PW-01, produced by OHARA INC.

### Solvent (D)

The solvent (D) used in the conductive paste of the present invention is not particularly limited as long as it is compatible with the pigment dispersion resin (A) and can disperse the conductive carbon (B). Specific examples include hydrocarbon solvents, such as n-butane, n-hexane, n-heptane, n-octane, cyclopentane, cyclohexane, and cyclobutane; aromatic-based solvents, such as toluene and xylene; ketone-based solvents, such as methyl isobutyl ketone; ether-based solvents, such as n-butyl ether, dioxane, ethylene glycol monomethyl ether, ethylene glycol monoethyl ether, ethylene glycol monobutyl ether, and diethylene glycol; ester-based solvents, such as ethyl acetate, n-butyl acetate, isobutyl acetate, ethylene glycol monomethyl ether acetate, and butylcarbitol acetate; ketone-based solvents, such as methyl ethyl ketone, methyl isobutyl ketone, and diisobutyl ketone; alcohol-based solvents, such as ethanol, isopropanol, n-butanol, sec-butanol, and isobutanol; and amide-based solvents, such as Equamide (trade name, produced by Idemitsu Kosan Co., Ltd., amide-based solvent), N, N-dimethylformamide, N, N-dimethylacetamide, N-methylformamide, N-methylacetamide, N-methylpropionamide, and N-methyl-2-pyrrolidone. Of these, N-methyl-2-pyrrolidone is preferable. These solvents may be used alone or in a combination of two or more.

The solvent (D) usable in the conductive paste of the present invention preferably comprises a solvent having a polar functional group, such as a hydroxy group, carboxy group, amide group, amino group, or ether group, from the viewpoint of the solubility of the pigment dispersion resin (A) having an active hydrogen group and the storage stability of the conductive pigment paste.

It is preferable that water is not substantially contained, from the viewpoint of pigment dispersibility of the conductive paste and avoiding a change in quality or hydrolysis of the resin components. The phrase “water is not substantially contained” as used here means that the water content is usually 1 mass % or less, preferably 0.5 mass % or less, and particularly preferably 0.1 mass % or less, based on the total amount of the conductive pigment paste.

In the present invention, the water content of the conductive paste can be measured by the Karl Fischer coulometric titration method. Specifically, the measurement can be performed using a Karl Fischer moisture analyzer (produced by Kyoto Electronics Manufacturing Co., Ltd., trade name: MKC-610), and setting a moisture evaporator (produced by Kyoto Electronics Manufacturing Co., Ltd., trade name: ADP-611) provided in the Karl Fischer moisture analyzer to a temperature of 130° C.

The solubility parameter δA of the pigment dispersion resin (A) and the solubility parameter δD of the solvent (D) preferably satisfy the relationship |δA−δD|<2.0.

The solubility parameter δA of the pigment dispersion resin (A) is, for example, 9.3 or more, preferably 10.0 or more, and more preferably 11.0 or more, and is, for example, 13.5 or less, preferably 13.0 or less, and more preferably 12.5 or less, from the viewpoint of pigment dispersibility, storage stability, and compatibility with solvents.

The units of the solubility parameters above are all “(cal/cm³)^{1/2}.”

The solubility parameter of a resin is numerically quantified on the basis of a turbidity measurement method that is known to a person skilled in the art. Specifically, the solubility parameter can be determined according to the formula suggested by K. W. Suh and J. M. Corbett (Journal of Applied Polymer Science, 12, 2359, 1968).

When two or more pigment dispersion resins are used for the pigment dispersion resin (A), the “solubility parameter δA of the pigment dispersion resin (A)” is the sum of the solubility parameter values of each resin multiplied by the mass fraction.

### Other Additives

The conductive paste of the present invention may comprise components other than the above components (A), (B), (C), and (D) (sometimes referred to as “other additives”). Examples of other additives can include neutralizing agents, pigment dispersants, defoaming agents, preservatives, anti-rust agents, plasticizers, and binding agents (binders).

Examples of pigment dispersants and/or binding agents include acrylic resins, polyester resins, epoxy resins, polyether resins, alkyd resins, urethane resins, silicone resins, polycarbonate resins, silicate resins, chlorine-based resins, fluorine-based resins, polyvinylpyrrolidone resins, polyvinyl alcohol resins, polyvinyl acetal resins, and composite resins thereof, other than the dispersion resin (A) above. These resins may be used alone or in a combination of two or more. Of these, polyvinylidene fluoride (PVDF) is particularly preferable.

The conductive paste of the present invention may optionally comprise an acidic compound. The acidic compound is not particularly limited, and both inorganic and organic acids may be used. Examples of inorganic acids include hydrochloric acid, sulfuric acid, nitrate, and phosphate. Examples of organic acids include carboxylic acid compounds and sulfonic acid compounds. Examples of carboxylic acid compounds include formic acid, acetic acid, propionic acid, butyric acid, tartaric acid, oxalic acid, malonic acid, succinic acid, glutaric acid, adipic acid, pimelic acid, suberic acid, (meth)acrylic acid, crotonic acid, fumaric acid, maleic acid, itaconic acid, citraconic acid, and fluoroacetic acid. Examples of sulfonic acid compounds include methanesulfonic acid, para-toluenesulfonic acid, dodecylbenzenesulfonic acid, dinonylnaphthalenesulfonic acid, and dinonylnaphthalenedisulfonic acid. In addition to the above, anhydrides or hydrates of these acidic compounds, or acidic compounds in which a portion is a salt form may also be used. These may be used alone or in a combination of two or more.

### Method for Producing Conductive Paste of Present Invention

The total solids content of the dispersion resin (A) in the solids of the conductive paste of the present invention is not limited and is usually 20 to 99.95 mass %, preferably 40 to 99.9 mass %, and more preferably 60 to 99.7 mass % in terms of conductivity and the like.

The solids content of the inorganic material (C) in the solids of the conductive paste of the present invention is not limited and is usually 0.05 to 80 mass %, preferably 0.1 to 60 mass %, and more preferably 0.3 to 40 mass %, from the viewpoint of conductivity and the like.

The content of the solvent (D) in the conductive paste of the present invention is not limited and is usually 65 to 99.9 mass %, preferably 70 to 99.5 mass %, and more preferably 75 to 99 mass %, from the viewpoint of viscosity at the time of pigment dispersion, pigment dispersibility, storage stability, and production efficiency.

The conductive paste of the present invention may be prepared by uniformly mixing and dispersing each component described above by using, for example, a known dispersion device, such as a paint shaker, a sand mill, a ball mill, a pebble mill, an LMZ mill, a DCP pearl mill, a planetary ball mill, a homogenizer, a twin-screw kneader, and a thin-film spin system high-speed mixer.

As described later, the conductive paste of the present invention may be used to produce a mixture paste by mixing with an electrode active material. The mixture paste may be used to produce a positive electrode of a lithium-ion battery. Thus, in a preferable embodiment, the conductive paste of the present invention is a conductive paste for positive electrodes of lithium-ion batteries.

### Mixture Paste

The present invention provides a mixture paste comprising the conductive paste described above, and further comprising an electrode active material.

### Electrode Active Material

Examples of electrode active materials include lithium nickel oxide (LiNiO₂), lithium manganese oxide (LiMn₂O₄), lithium cobalt oxide (LiCoO₂), LiNi_{1/3}Co_{1/3} Mn_{1/3}O₂LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, NCA, lithium ferrous phosphate (LFP), lithium manganese ferrous phosphate (LMFP), lithium manganese phosphate (LMP), lithium cobalt phosphate (LCP), lithium nickel phosphate (LNP), LNMO, and other lithium composite oxides. These electrode active materials may be used alone or in a combination of two or more. The solids content of the electrode active material in the solids of the mixture paste of the present invention is usually 70 mass % or more and less than 100 mass %, and preferably 80 masse or more and less than 100 mass %, in terms of, for example, battery capacity and battery resistance.

### Method for Producing Mixture Paste

The mixture paste of the present invention can be obtained by first preparing the conductive paste described above and then blending an electrode active material with the conductive paste. The mixture paste of the present invention may also be prepared by mixing the components (A), (B), (C), and (D) described above with an electrode active material.

The total solids content of the dispersion resin (A) in the solids of the mixture paste of the present invention is not particularly limited and is usually 0.01 to 50 mass % or less, preferably 0.05 to 30 mass %, and more preferably 0.1 to 20 mass %, in terms of, for example, production efficiency and conductivity.

The solids content of the inorganic material (C) in the solids of the mixture paste of the present invention is not particularly limited and is usually 0.01 to 10 mass %, preferably 0.02 to 5 mass %, and more preferably 0.05 to 3 mass %, from the viewpoint of conductivity of the mixture layer.

The content of the solvent (D) in the mixture paste of the present invention is not limited and is usually 25 to 55 mass %, preferably 30 to 50 mass %, and more preferably 35 to 45 mass %, from the viewpoint of the viscosity at the time of pigment dispersion, pigment dispersibility, storage stability, and productivity.

### Method for Producing Electrode for Positive Electrodes of Lithium-Ion Batteries

A positive electrode mixture layer of a lithium-ion secondary battery can be produced by applying the mixture paste to a surface of a positive electrode core, followed by drying. The paste of the present invention can be used as a paste for forming a mixture layer, and also for forming a primer layer between a positive electrode core and a synthesis layer.

The mixture paste may be applied by using a known method that uses a die coater or the like. The amount of the mixture paste to be applied is not particularly limited. For example, the amount may be set such that the thickness of the positive electrode mixture layer after drying is within the range of 0.04 to 0.30 mm, and preferably 0.06 to 0.24 mm. The temperature of the drying step may be appropriately set, for example, within the range of 80 to 200° C., and preferably 100 to 180° C. The time for the drying step may be appropriately set, for example, within the range of 5 to 120 seconds, and preferably 5 to 60 seconds.

### Battery

The present invention provides a battery obtained by using the electrode described above. Typically, the battery of the present invention comprises the electrode for positive electrodes of lithium-ion batteries described above, an electrolyte layer, and an electrode for negative electrodes. The battery of the present invention includes, for example, a non-aqueous electrolyte lithium-ion battery, which uses a non-aqueous electrolyte for the electrolyte layer, and an all-solid-state lithium-ion battery, which uses a solid electrolyte for the electrolyte layer.

In the present invention, non-aqueous electrolyte lithium-ion batteries include, for example, a lithium-ion secondary battery comprising a microporous separator provided between a positive electrode and negative electrode, an ion-conductive non-aqueous electrolyte solution, and the like, and a lithium polymer secondary battery comprising a polymer that absorbs a non-aqueous electrolyte solution etc. as a separator between a positive electrode and negative electrode. In the present invention, all-solid-state lithium-ion batteries include, for example, a battery comprising as a lithium ion-conductive solid electrolyte, a material obtained by sintering at least one material selected from the group consisting of a glass electrolyte, ceramic electrolyte, and glass ceramic electrolyte.

The non-aqueous electrolyte solution for use may be any known non-aqueous electrolyte solution. For example, one obtained by dissolving a lithium salt in an organic solvent can be used. The organic solvent for use here may be, for example, an ester-based, ether-based, carbonate-based, or ketone-based solvent.

The lithium salt for use may be, for example, LiPF₆, LiBF₄, LiClO₄, LiN(SO₂CF₃)₂, LiN(SO₂C₂F₅)₂, or LiC(SO₂CF₃)₃.

The non-aqueous electrolyte solution for use may be a room-temperature molten salt with lithium ion conductivity. The room-temperature molten salt with lithium ion conductivity for use may be those obtained by mixing a molten salt, such as EMI-TFSI (1-ethyl-3-methylimidazolium-bis(trifluoromethanesulfonyl)imide), EMI-BF₄ (1-ethyl-3-methylimidazolium tetrafluoroborate), TMPA-TFSI (trimethylpropylammonium-bistrifluoromethylsulfonylimide), or PP1₃ (N-methyl-N-propylpiperidinium), with a lithium salt, such as LiBF₄ (lithium tetrafluoroborate), LiClO₄ (lithium perchlorate), LiN(SO₂CF₃)₂ (lithium bistrifluoromethanesulfonimide), LiN(SO₂C₂F₅)₂ (lithium bis(pentafluoroethanesulfonyl)imide), LiSO₃CF₃ (lithium trifluoromethanesulfonate), or LiPF₆ (lithium hexafluorophosphate). However, the room-temperature molten salt is not limited to these and various molten salts, lithium salts, and the like can be used. Further, the room temperature molten salts above may be mixed with non-aqueous solvents.

### EXAMPLES

The present invention is described in more detail below with reference to Examples and Comparative Examples. However, the present invention is not limited to these Examples.

Below, “AB” stands for acetylene black, “CNT” for carbon nanotube, “PVA” for polyvinyl alcohol, and “PVDF” for polyvinylidene fluoride.

### Production of Conductive Paste

### Examples 1 to 9 and Comparative Examples 1 to 7

The components in Tables 1 and 2 below, except for the glass ceramic, were added to a container and mixed with a disperser for 10 minutes. Subsequently, the mixture was dispersed in Scandex (trade name, LAU Disperser, produced by O-Well Corporation), and the glass ceramic was added while the dispersed solution was stirred with a disperser. After the addition, the mixture was mixed with a disperser for 10 minutes to thereby obtain conductive pastes X-1 to X-9 and Y-1 to Y-7.

For X-1 to X-6 and Y-1 to Y-3, dispersion was performed in Scandex for 3 hours, and for X-7 to X-9 and Y-4 to Y-7, dispersion was performed in Scandex for 6 hours. The amounts of dispersion resins in the tables are based on a solids content.

TABLE 1

| | | Examples | | | | | | Comparative Examples | | |
|---|---|---|---|---|---|---|---|---|---|---|
| Examples and Comparative Examples | | 1 | 2 | 3 | 4 | 5 | 6 | 1 | 2 | 3 |
| Conductive paste | | X-1 | X-2 | X-3 | X-4 | X-5 | X-6 | Y-1 | Y-2 | Y-3 |
| Dispersion | A: PVA (saponification degree: 99.9, | 12 | 12 | 12 | | | | 12 | | |
| resin | polymerization degree: 300) | | | | | | | | | |
| | B: PVA (saponification degree: 70, | | | | 12 | | | | | |
| | polymerization degree: 300) | | | | | | | | | |
| | C: Sulfonic acid-modified PVA (saponification | | | | | 12 | | | | |
| | degree: 90, polymerization degree: 300) | | | | | | | | | |
| | D: Acrylic resin (Note 1) | | | | | | 12 | | | |
| | E: PVDF (polymerization degree: one million) | | | | | | | | 12 | |
| CNT | Enermax 12 (Note 2) | 40 | 40 | 40 | 40 | 40 | 40 | 40 | 40 | 40 |
| Solvent | N-methyl-2-pyrrolidone (favorite) | 948 | 948 | 948 | 948 | 948 | 948 | 948 | 948 | 960 |
| Glass ceramic | LICGC (Note 3) | 20 | 10 | 0.2 | 10 | 10 | 10 | | 10 | 10 |
| Viscosity | Viscosity at 1/s (Pa · s) | 0.01 | 0.01 | 0.01 | 0.01 | 0.01 | 0.01 | 0.01 | 54.80 | 26.10 |
| | Evaluation | S | S | S | S | S | S | S | C | C |
| Battery | DC resistance (Ω) @ initial cycle, 25° C. | 1.76 | 1.69 | 1.70 | 1.70 | 1.71 | 1.70 | 1.77 | — | — |
| performance | DC resistance (Ω) @ initial cycle, −20° C. | 49.72 | 50.39 | 50.83 | 50.45 | 49.90 | 49.20 | 51.39 | — | — |
| | DC resistance (Ω) @ 100th cycle, 25° C. | 3.36 | 2.94 | 2.96 | 3.00 | 2.92 | 3.10 | 3.53 | — | — |
| | DC resistance (Ω) @ 100th cycle, −20° C. | 85.65 | 83.57 | 85.77 | 83.70 | 83.40 | 83.90 | 87.80 | — | — |
| | Evaluation | Accept- | Accept- | Accept- | Accept- | Accept- | Accept- | Un- | — | — |
| | | able | able | able | able | able | able | accept- | | |
| | | | | | | | | able | | |

(Note 1):
Acrylic resin: polyacrylic acid, weight average molecular weight: 15, 000
(Note 2):
Enermax 12: carbon nanotube, average outer diameter (diameter): 30 to 50 nm, average length: 5 to 12 μm, specific surface area (BET): 85 to 110 m²/g
(Note 3):
LICGC: produced by OHARA INC., lithium-ion conductive glass ceramic LICGC ™ PW-01, 0.4 μm

TABLE 2

| | | Examples | | | Comparative Examples | | | |
|---|---|---|---|---|---|---|---|---|
| Examples and Comparative Examples | | 7 | 8 | 9 | 4 | 5 | 6 | 7 |
| Conductive paste | | X-7 | X-8 | X-9 | Y-4 | Y-7 | Y-5 | Y-6 |
| Dispersion | A: PVA (saponification degree: 99.9, polymerization degree: 300) | 3 | | | 3 | | | |
| resin | B: PVA (saponification degree: 70, polymerization degree: 300) | | 3 | | | | | |
| | C: Sulfonic acid-modified PVA (saponification degree: 90, | | | 3 | | | | |
| | polymerization degree: 300) | | | | | | | |
| | E: PVDF (polymerization degree: one million) | | | | | 3 | | |
| AB | Denka black granules, average primary particle size: 35 nm | 130 | 130 | 130 | 130 | 130 | 130 | 130 |
| Solvent | N-methyl-2-pyrrolidone (favorite) | 867 | 867 | 867 | 867 | 867 | 870 | 870 |
| Glass ceramic | LICGC (Note 3) | 33 | 33 | 33 | | 33 | 33 | |
| Viscosity | Viscosity at 1/s (Pa · s) | 10.6 | 22.4 | 24.5 | 9.0 | Unmeasurable | | |
| | Evaluation | B | B | B | A | D | D | D |
| Battery | DC resistance (Ω) @ initial cycle, 25° C. | 1.77 | 1.79 | 1.76 | 1.78 | — | — | — |
| performance | DC resistance (Ω) @ initial cycle, −20° C. | 103.5 | 103.6 | 103.2 | 103.3 | — | — | — |
| | DC resistance (Ω) @ 100th cycle, 25° C. | 3.90 | 3.95 | 3.88 | 4.30 | — | — | — |
| | DC resistance (Ω) @ 100th cycle, −20° C. | 150.5 | 151.0 | 149.8 | 156.4 | — | — | — |
| | Evaluation | Accept- | Accept- | Accept- | Un- | — | — | — |
| | | able | able | able | accept- | | | |
| | | | | | able | | | |

### Viscosity Measurement

The viscosity of the conductive pastes obtained in the Examples and Comparative Examples was measured at 25° C. by using a cone and plate viscometer (produced by Thermo Fisher Scientific K.K., trade name HAAKE Mars 3, diameter: 35 mm, a 2° inclined cone and plate) at a shear rate of 1.0 sec⁻¹, and evaluated according to the following criteria.

S, A, and B are regarded as acceptable, and C and D are regarded as unacceptable.

The evaluation results are shown in Tables 1 and 2 above.
S: The viscosity is less than 1.0 Pa·s.
A: The viscosity is 1.0 Pa·s or more and less than 10.0 Pa·s.
B: The viscosity is 10.0 Pa·s or more and less than 25.0 Pa·s.
C: The viscosity is 25.0 Pa·s or more.
D: The viscosity is unmeasurable.

### Production of Positive Electrode Slurry

### Production of Positive Electrode Slurry Using Carbon Nanotube (CNT)

LiCoO₂ (average particle size: 5 μm), the conductive pastes X-1 to X-6 and Y-1 (to which the CNT was applied) obtained in the Examples, and polyvinylidene fluoride (PVDF) diluted to 5 wt % with N-methyl-2-pyrrolidone (NMP) as a binding agent were mixed in a material weight ratio of LiCoO₂:CNT:PVDF=97:1.5:1.5. Then, the mixture was stirred and mixed with a disperser while N-methyl-2-pyrrolidone (NMP) was added as appropriate such that the solids content was within the range of 55 to 60%, thereby obtaining slurries for application to positive electrodes.

### Production of Positive Electrode Slurry Using Acetylene Black (AB)

LiCoO₂ (average particle size: 8 μm), the conductive pastes X-7 to X-9 and Y-4 (to which AB was applied) obtained in the Examples, and polyvinylidene fluoride (PVDF) diluted to 5 wt % with N-methyl-2-pyrrolidone (NMP) as a binding agent were mixed in a material weight ratio of LiCoO₂:AB:PVDF=92:4:4. Then, the mixture was stirred and mixed with a disperser while N-methyl-2-pyrrolidone (NMP) was added as appropriate such that the solids content was within the range of 60 to 65%, thereby obtaining slurries for application to positive electrodes.

### Production of Lithium-Ion Battery

### Production of Positive Electrode Sheet

Each of the slurries was applied to a 20 μm-thick aluminum foil with an applicator and was then dried to obtain a sheet for positive electrodes. The obtained sheet for positive electrodes was pressed with a roll press to a density of 2.9 g/cm³ to obtain a positive electrode sheet.

The dry film thickness of the slurry is as shown in the “Fine Adjustment of Positive and Negative Electrode Capacity Ratio” section below.

### Negative Electrode Sheet

For the negative electrode sheet, HIS-LIB-N-Gr-002 spherulite graphite TSG-A1 (3.2 mAh/cm², produced by Hohsen Corp.) was used.

### Fine Adjustment of Positive and Negative Electrode Capacity Ratio

The thickness of each of the slurries for application of positive electrodes at the time of application was finely adjusted such that the ratio of the capacity of the opposing side of the positive electrode sheet to the capacity of the negative electrode sheet was 1.05 to 1.2.

### Electrolyte Solution

For the lithium-ion battery, the electrolyte solution used was a liquid obtained by mixing 2 wt % of vinylene carbonate (VC) with a solvent in which ethylene carbonate (EC) and ethyl methyl carbonate (EMC) were mixed in a volume ratio of 1:3, and further dissolving an electrolyte LiPF₆ in the mixture to a concentration of 1 mol/L.

### Production of Two-Electrode Cell (Lithium-Ion Battery)

The positive electrode sheet and negative electrode sheet described above were punched to obtain a positive electrode piece and a negative electrode having coated areas of 18 cm² and 19.74 cm², respectively. An aluminum tab was attached to the aluminum foil of the positive electrode piece and a nickel tab to the copper foil of the negative electrode piece. A polypropylene microporous film (Selion P2010, produced by CS Tech Co., Ltd.) was placed between the positive electrode piece and the negative electrode piece so that the positive electrode piece fit on the opposite side of the negative electrode piece. The resulting product was then placed inside a bag-shaped aluminum laminate packaging material, and 0.75 ml of the electrolyte solution was introduced. The opening portion was then sealed with a small vacuum packaging machine (trade name SV-150, produced by Tosei Corporation) to obtain a two-electrode cell for evaluation.

### Battery Performance Evaluation

### Cycle Test

One hundred cycles of charging and discharging were conducted at 45° C. for the lithium-ion batteries obtained by using the conductive pastes (positive electrode slurries) comprising AB of the Examples and Comparative Examples, and at 60° C. for the lithium-ion batteries obtained by using the conductive pastes comprising the CNT, with a battery charging/discharging device (trade name HJ1001SD8, produced by Hokuto Denko Corporation), such that charging was performed to 4.35 V with a current of 0.5 C, and after resting for 30 minutes, discharging was performed to 3 V with a current of 1 C.

### DC Resistance Measurement

The lithium-ion batteries obtained by using the conductive pastes (positive electrode slurries) of the Examples and Comparative Examples were measured for DC resistance at the first cycle (initial) and at the 100th cycle with a battery charge/discharge device (produced by Hokuto Denko Corporation, trade name HJ1001SD8). The DC resistance was measured at a specified temperature after charging to 4.35 V with a current of ⅓ C at 25° C., resting for 30 minutes, discharging with a current of ⅓ C for 1.5 hours, and then resting for 3 hours. The DC resistance at 25° C. was calculated from the slope of a plot obtained by performing discharging and charging alternatively for 10 seconds with currents of ⅕ C, ½ C, 1 C, and 2 C, and extracting the voltage and current values after 10 seconds of discharge. The DC resistance at −20° C. was calculated from the slope of a plot obtained by performing discharging and charging alternatively for 10 seconds with currents of 1/200 C, 1/100 C, 1/80 C, and 1/60 C, and extracting the voltage and current values after 10 seconds of discharge. A 30-minute resting period was provided between discharging and charging.

Evaluation when CNT was Contained

The lithium-ion batteries obtained by using the conductive pastes comprising CNT were evaluated according to the following criteria. In this evaluation, the battery performance is regarded as acceptable when the results of both tests of 25° C. and −20° C. were acceptable.

Acceptable: The DC resistance at an ordinary temperature (25° C.) at the 100th cycle was less than 3.5Ω.

Acceptable: The DC resistance at a low temperature (−20° C.) at the 100th cycle was less than 87Ω.

Unacceptable: The DC resistance at an ordinary temperature (25° C.) at the 100th cycle was 3.5Ω or more.

Unacceptable: The DC resistance at a low temperature (−20° C.) at the 100th cycle was 87Ω or more.

Evaluation when AB was Contained

The lithium-ion batteries obtained by using the conductive pastes comprising AB were evaluated according to the following criteria. In this evaluation, the battery performance is regarded as acceptable when the results of both tests of 25° C. and −20° C. were acceptable.

Acceptable: The DC resistance at an ordinary temperature (25° C.) at the 100th cycle was less than 4.0Ω.

Acceptable: The DC resistance at a low temperature (−20° C.) at the 100th cycle was less than 155Ω.

Unacceptable: The DC resistance at an ordinary temperature (25° C.) at the 100th cycle was 4.0Ω or more.

Unacceptable: The DC resistance at a low temperature (−20° C.) at the 100th cycle was 155Ω or more.

The present invention was described in detail above with reference to the Examples. However, the present invention is not limited to the above Examples, and various modifications can be made based on the technical idea of the present invention.

For example, the compositions and numerical values stated in the Examples above are merely examples, and compositions and numerical values that differ from those may be used, if necessary.

Although the above Examples show examples in which a glass ceramic was used as the inorganic material, the glass or ceramic disclosed in this specification can also be suitably used.

1. A conductive paste comprising a pigment dispersion resin (A), a conductive carbon (B), an inorganic material (C), and a solvent (D),
wherein the pigment dispersion resin (A) has at least one polar functional group selected from the group consisting of an amide group, imide group, ether group, hydroxy group, carboxy group, sulfonate group, phosphate group, silanol group, amino group, and pyrrolidone group, and
wherein the inorganic material (C) comprises at least one member selected from the group consisting of a glass, glass ceramic, and ceramic.

2. The conductive paste according to claim 1, wherein the pigment dispersion resin (A) has a polar functional group concentration of 0.1 to 23 mmol/g.

3. The conductive paste according to claim 1, wherein the pigment dispersion resin (A) comprises a polyvinyl alcohol resin (a1) having a saponification degree of 30 to 100 mol %.

4. The conductive paste according to claim 1, wherein the pigment dispersion resin (A) comprises an acrylic resin (a2).

5. The conductive paste according to claim 1, wherein the conductive carbon (B) comprises acetylene black (b1) and/or a carbon nanotube (b2).

6. The conductive paste according to claim 1, wherein the conductive carbon (B) comprises a carbon nanotube (b2).

7. The conductive paste according to claim 5, wherein the carbon nanotube (b2) has a fiber length of 0.1 to 100 μm and an outer diameter of 1 to 30 nm.

8. The conductive paste according to claim 1, wherein the inorganic material (C) comprises, on a percent by mass basis,
P₂O₅: 15 to 60%,
SiO₂: 0 to 15%,
MO₂: 20 to 45%, wherein M represents one or more members selected from the group consisting of Ti, Zr, Ge, Sn, Nb, and Hf,
A₂O₃: 0 to 25%, wherein A represents one or more members selected from the group consisting of Al, Y, and Sc,
EO: 0 to 25%, wherein E represents one or more members selected from the group consisting of Mg and Ca, and
Li₂O: 3 to 20%.

9. The conductive paste according to claim 8,
wherein the inorganic material (C) is a glass ceramic and/or ceramic in which a crystal of Li₁₊ₓM1_{y}M2_{2-y}Si_{z}P_{1-z}O₁₂ (0<x<2, 0<y<2, 0≤z≤1) is precipitated, wherein in the formula, M1 represents one or more members selected from the group consisting of Al, Ca, Y, Mg, and Sc, and M2 represents one or more members selected from the group consisting of Ti, Zr, Ge, Sn, Nb, and Hf.

10. The conductive paste according to claim 1, wherein the solubility parameter δA of the pigment dispersion resin (A) and the solubility parameter δD of the solvent (D) satisfy the relationship |δA−δD|<2.0.

11. The conductive paste according to claim 1, wherein the solvent (D) comprises N-methyl-2-pyrrolidone.

12. The conductive paste according to claim 1, wherein the conductive paste has a water content of less than 1.0 mass %.

13. A mixture paste comprising the conductive paste of claim 1, and further comprising an electrode active material (E).

14. A mixture paste comprising a pigment dispersion resin (A), a conductive carbon (B), an inorganic material (C), a solvent (D), and an electrode active material (E),
wherein the pigment dispersion resin (A) has at least one polar functional group selected from the group consisting of an ester group, amide group, imide group, ether group, hydroxy group, carboxy group, sulfonate group, phosphate group, silanol group, amino group, and pyrrolidone group, and
wherein the inorganic material (C) comprises at least one member selected from the group consisting of a glass, glass ceramic, and ceramic.

15. An electrode for positive electrodes of non-aqueous electrolyte lithium-ion batteries obtained by using the mixture paste of claim 13.

16. An electrode for positive electrodes of solid electrolyte lithium-ion batteries obtained by using the mixture paste of claim 13.

17. An all-solid-state battery obtained by using the electrode for positive electrodes of claim 16.
